(19) United States
(12) Patent Application Publication
(10) Pub. No.: US 2025/0322286 A1
(43) Pub. Date: Oct. 16, 2025

(54) INTELLIGENCE ACQUISITION VIA CONVERSATIONAL INTERACTIONS AND MICRO-CREDENTIAL COMPETENCY LOGIC

(71) Applicant: BANK OF AMERICA CORPORATION, Charlotte, NC (US)

(72) Inventors: Malinda Mae Kieffer, Chillicothe, MO (US); Kiran Boosetty, Saint Johns, FL (US); Gerard P. Gay, Seattle, WA (US); Andrzej Grabski, Glen Rock, NJ (US); Rahul Kumar Mishra, Skillman, NJ (US); Samuel M. Moiyallah, JR., Newark, DE (US); Susan Moss, Vestal, NY (US); Donna Lee Phillips, Elkton, MD (US); Robert Ronald Rosseland, JR., Huntersville, NC (US); Ravinder Kaur Sodhi, Royse City, TX (US); Tanya A. Wilson, Newark, DE (US)

(73) Assignee: BANK OF AMERICA CORPORATION, Charlotte, NC (US)

(21) Appl. No.: 18/631,446

(22) Filed: Apr. 10, 2024

(51) Int. Cl. G06N 20/00

(52) U.S. Cl. CPC G06N 20/00

(57) ABSTRACT

Intelligence acquisition is conducted via conversational interactions and micro-credential competency logic. An AI system including ML models are trained to generate segments associated with at least one subject matter and determine which of the segments to present to a user and/or assess a level of competency of the user in the subject matters associated with the segments. A learning application identifies the user and, in response, receives characteristic data and/or historical learning data associated with the user. In response, the learning application determines, using the ML models, the segment(s) to present to the user based, at least, on the characteristic data and/or historical learning data. Once the determined segments are presented, the learning application conducts a series of conversational interactions with the user using the artificial intelligence system and assesses the level of competency of the user in subject matter(s) associated the presented segment.

### TECHNOLOGICAL FIELD

The present invention is related generally to learning tools and applications and, more specifically, using artificial intelligence, including machine learning, to conduct conversational interactions with the users and assess the users' competency in a variety of subject matters through learning applications.

### BACKGROUND

Applicant has identified a number of deficiencies and problems associated with traditional learning tools. Traditional multimedia learning tools are designed to present users with material related to a specific subject matter. The material may be presented, for example, through videos, audio and/or through text on screen. Typically, users are quizzed periodically in between the presentation of material or at the end. However, traditional learning tools do not engage with the user consistently and throughout the presentation of the material. Such dynamic engagement with users, while presenting the material to be learned, is important and necessary for users to really understand the material presented to them and to test their understanding of the material as well.

Therefore, a need exists to develop systems, computerized methods, computer program products and the like that allow learning tools to engage with users to improve and assess the competency of the user in the material the user needs to learn. Through applied effort, ingenuity, and innovation, many of the problems identified with traditional learning tools have been solved by developing solutions that are included in embodiments of the present disclosure, many examples of which are described in detail herein.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide for the systems, methods, computer program products and the like that provide for implementing a learning application across all known and future known computing platforms/systems. Specifically, learning applications are implemented with the use of artificial intelligence, including machine learning, and use conversational interactions with the user to improve and assess the user's competency in any given subject matter.

In accordance with embodiments of the present invention, an artificial intelligence system includes at least one machine learning model. A learning application identifies the individual using the application and gathers data regarding that user, such as the user's characteristic data and historical learning data, with the help of the artificial intelligence system. The machine learning models are trained to determine which subject matters need to be presented to the user based on data related to the user gathered by the learning application. The models are further trained to generate segments for the user containing material related to the determined subject matters. The learning application then presents the material to the user by facilitating a series of conversational interactions between the user and the artificial intelligence system.

In specific embodiments of the invention, the machine learning models are trained to assess the user's competency in the material presented to the user, based at least in part on the interactions they conduct with the user. In specific embodiments of the invention, the models assess the user's competency by analyzing the user interactions, including determining the time taken by the user to respond in the interaction sessions. In other embodiments of the invention, the conversational interactions with the user continue until the user has achieved a threshold level of competency in the material presented.

In other specific embodiments of the invention, the learning application presents the material to the user in a pop-up window when the user is not actively engaged with the learning application, the learning application facilitates the conversational interactions with the user through the pop-window, and the machine learning models assess the user's competency in the material presented through the pop-up window interactions. In a further embodiment, the artificial intelligence system triggers the learning application to present material in the pop-up window when the user's interactions with a secondary application or information being presented in a secondary application are related to subject matter the user needs to be trained in.

In further embodiments of the invention, the machine learning models are further trained to keep up with any changes to material associated with a variety of subject matter, to use the data of multiple users within an entity to determine which material to present to a specific user and update a specific user's historical learning data based on the interactions with that user.

A system for implementing learning tools defines first embodiments of the invention. The system includes an artificial intelligence system and a learning application. The artificial intelligence system includes at least one machine learning model. The learning application is configured to identify the individual using the application and receive data regarding that user. Such data includes, but is not limited to, characteristic data, such as occupation, duties, or the like and historical learning data, such as past trainings, scores on prior training assessments, or the like

A machine learning model is configured to determine, using the user's data, which subject matter needs to be presented to the user. The model is further configured to generate at least one segment associated with the subject matter or combination of subject matters it determined to be presented to the user. The learning application, using the machine learning model, presents the determined segments to the user. The segments are presented to the user through interactions between the machine learning model and the user that occur via the learning application.

The machine learning model uses the interactions with the user to assess the user's competency in the material presented. In one embodiment of the invention, the learning application is an interactive user application, and the machine learning model assesses the user's competency in the material from the segments presented to the user by analyzing the user's interactions with the model that are conducted through the learning application. In another embodiment, the machine learning model also determines and takes into account the time taken by the user to respond in the interactions when analyzing the user's interactions. In one more embodiment, the machine learning model is further configured to update the user's historical learning data based on the user's interactions and based on the model's assessment of the user's competency in the presented material.

In further embodiments of the invention, the machine learning model is further trained to determine a threshold level of competency the user must achieve in the material presented in a session based on the user's historical learning data or the subject matter associated with the segments presented to the user. The model then continues to have conversation interactions with the user while presenting the material until the user achieves the determined threshold level of competency.

In other embodiments of the invention, the learning application is configured to present the segments to the user in a pop-up window when the user is engaged with a secondary application and not the learning application. The machine learning model assesses the user's competency in the segment's material by conducting interactions with the user through the pop-up window.

In a further embodiment, the artificial intelligence system is configured to monitor the user's interactions with secondary applications and information presented in secondary applications as well. When there is material associated with any of a variety of subject matters that the learning application is used to train the user in and that material is related to the content of the user's interactions with a secondary application or to information presented in a secondary application, the artificial intelligence system triggers the learning application to open a pop-up window and present segments containing that material to the user through the pop-up window.

In yet another embodiment of the invention, the material associated with the variety of subject matters is subject to change. For example, laws may be updated, internal policies of an entity may change, and new rules and regulations related to a topic may be passed. The artificial intelligence system is configured to keep up with any changes to relevant subject matter and incorporate those changes into the segments generated by the machine learning models.

In other specific embodiments, the machine learning models are trained to use the characteristic or historical learning data of multiple users, which may include all users associated with an entity, in determining which segments to present to a specific user and in assessing the user's competency in the material. This would include using the data of multiple users to determine the threshold level of competency an individual needs to achieve in a session as well.

A computer implemented method for implementing learning tools defines second embodiments of the invention. The computer implemented method is executed by one or more computing processor devices. The method includes generating segments using machine learning, where each segment contains material related to at least one subject matter or a combination of subject matters. The method further includes identifying the user of the learning application and receiving data related to the user, such as characteristic data, historical learning data, or a combination of both. The method then includes using the user's data and machine learning to determine which segments to present and presenting those segments to the user. Finally, the method includes conducting a series of conversational interactions with the user and assessing the user's competency in the material presented to the user based on those interactions, all using machine learning.

A computer program product including a non-transitory computer-readable medium defines third embodiments of the invention. The computer-readable medium includes sets of codes for causing computing devices to generate segments using machine learning, where each segment contains material related to at least one subject matter or a combination of subject matters. The sets of codes further cause the computing devices to identify the user of the learning application and receive data related to the user, such as characteristic data, historical learning data, or a combination of both. The sets of codes then cause the computing devices to use the user's data and machine learning to determine which segments to present and present those segments to the user. Finally, the sets of codes cause the computing devices to conduct a series of conversational interactions with the user and assess the user's competency in the material presented to the user based on those interactions, all using machine learning.

Specific embodiments of the computer implemented method and computer program product include ones where assessing the user's competency includes analyzing the user's interactions, including how long the user takes to respond in interactions, and conducting interactions with the user until the user achieves a threshold level of competency determined by machine learning based on the user's historical learning data and the segments presented to the user. Further embodiments include ones where the machine learning models are configured to track changes to subject matter and incorporate those changes into the segments, use data related to multiple users, such as all users associated with an entity, to determine which segments to present to an individual user and assess an individual user's competency, and update historical learning data for a user based on the interactions with that user.

Other embodiments of the computer implemented method and computer program product include ones where segments are presented to the user through a pop-up window when the user is engaged with a secondary application, the user's competency is assessed through conversational interactions conducted via the pop-up window, and pop-up window is triggered when material in the segments is related to the user's interactions with the secondary application or information presented in the secondary application.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for implementing learning applications with conversational interactions using artificial intelligence, in accordance with an embodiment of the disclosure;

FIG. 2 illustrates a process flow for implementing learning applications with conversational interactions using artificial intelligence, in accordance with an embodiment of the disclosure.

FIG. 3 illustrates an exemplary architecture of a machine learning (ML) subsystem, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “satisfying the threshold” or “meeting the threshold” may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

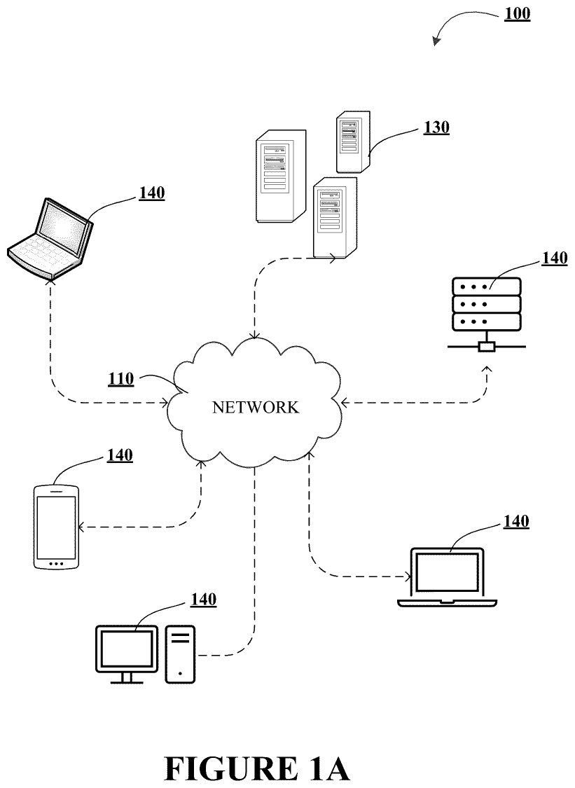

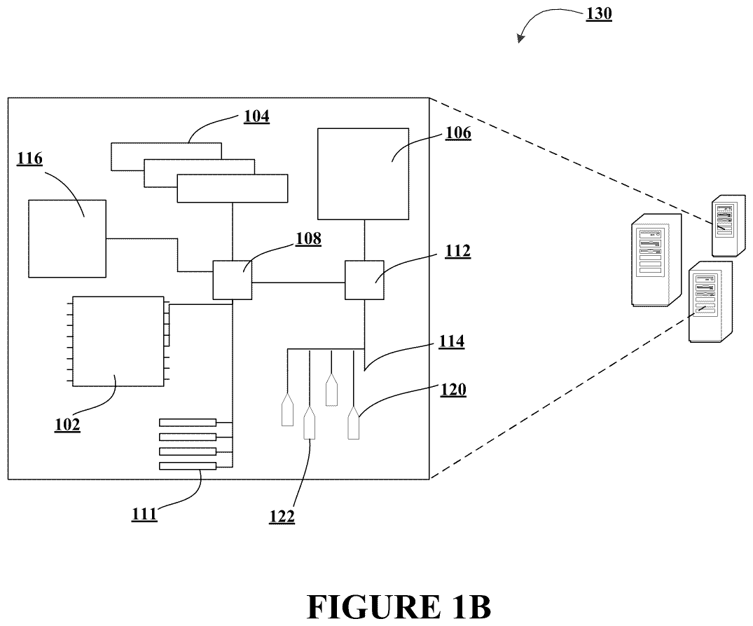

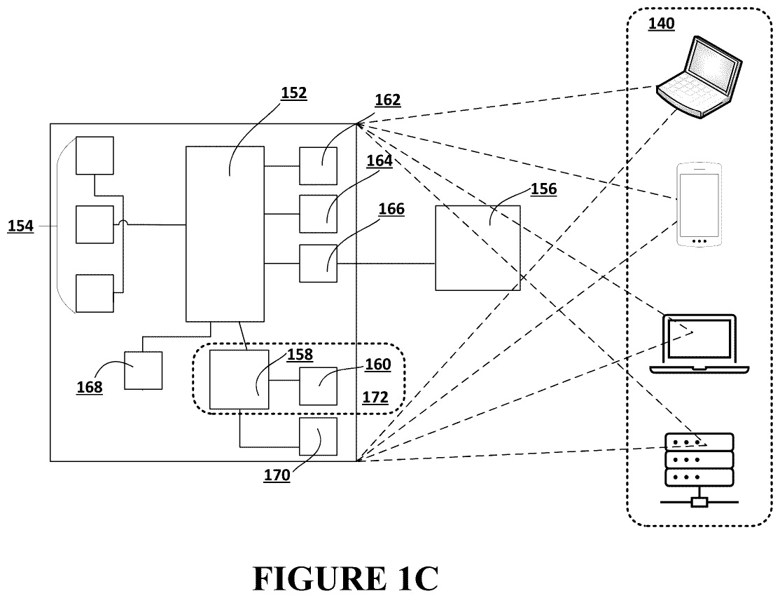

FIGS. 1A-1C illustrate technical components of an exemplary distributed computing environment 100 for implementing learning applications with conversational interactions, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low-speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low-speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards. In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, (e.g., through a network adapter). As shown in FIG. 1B, the system 130 may include one network interface 120 configured to communicate via a quantum network (e.g., a network configured to provide communication between devices and/or systems by transmitting and receiving qubits) and another network interface 122 configured to communicate via the communication network 110 (e.g., a network configured to provide communication between devices and/or systems by transmitting and receiving data packets).

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to execute instructions within the end-point device(s) 140, including instructions stored in the memory 154, which in one embodiment may include the instructions of an application that may perform the functions disclosed herein, including certain logic, data processing, and data storing functions. For example, the processor 152 may execute computer program code stored on a non-transitory storage device (e.g., the memory 154), which may cause the processor 152 to perform one or more of the process flows described herein. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and/or wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication and/or wireless communication, and the end-point device(s) 140 may include multiple external interfaces 168. In some embodiments, the control interface 164 and/or the display interface 166 may include a heads-up display work on the user's head, one or more devices worn by the user (e.g., on the user's hands), one of more devices held by the user (e.g., a controller device), and/or the like for rendering visual content, receiving input from the user, providing haptic feedback to the user, and/or the like. For example, the end-point device(s) 140 may be and/or include a virtual headset, a virtual reality system (e.g., including a headset and one or more accessories), and/or the like.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. Short-range communication may occur, such as using a Bluetooth, Wi-Fi, or other such transceiver. In some embodiments, the communication interface 158 and the transceiver 160 may form a network interface 172 configured to communicate via the communication network 110 (e.g., a network configured to provide communication between devices and/or systems by transmitting and receiving data packets). In addition, GPS (Global Positioning System) receiver module 170 may provide additional navigation- and location-related wireless data to end-point device(s) 140, which may be used as appropriate by applications running thereon, and in some embodiments, one or more applications operating on the system 130. The end-point device(s) 140 may also include another network interface 174 configured to communicate via a quantum network (e.g., a network configured to provide communication between devices and/or systems by transmitting and receiving qubits).

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, or the like.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

As noted, organizations and entities often use computer-based learning tools or platforms to train or teach associated users. Often, traditional or otherwise known learning tools or platforms present to their users the information the users need to learn as text or in an audio-visual format. The information in such traditional learning tools is generally presented in the form of discrete modules for specific topics or discrete subject matter. The traditional learning tools tend to quiz the user at the end of the module, and sometimes during the module, with pre-determined questions, such that users who answer a pre-determined number of questions correctly “pass” the module.

The problem with the structure of traditional learning tools and platforms is that the quizzes may not actually test the user's understanding of the material, but rather tests short term retention of the information just presented to them. Additionally, such tools and platforms do not allow for users who do not understand the material to do anything about it, i.e., they cannot ask questions or otherwise try to deepen their understanding. Users have to take what's presented to them, whether it is effective for them or not.

A solution to this problem with traditional learning tools and platforms is for embodiments of the present invention (e.g., new learning tools or the like) to interact with the user consistently throughout the segments to help the user understand the material presented and to consistently assess the user's understanding and modify the information presented accordingly. In specific embodiments of the invention, such learning tools also allow for the user to ask questions of the learning tool where the user believes the user could use additional information or help to understand the material.

Accordingly, the present invention is directed to systems and methods that employ artificial intelligence, including machine learning, in a learning system that provides for conversational interactions between the system and the user to simultaneously present material to the user and assess the user's understanding of that material. In specific embodiments of the invention, the system then uses its assessment to modify further interactions with the user and material presented to the user. In some embodiments of the invention, the system's assessment of the user includes analyzing user data including historical user data, current user data, historical communications with the user, current communication data, time taken for the user to respond in interactions, and/or the like.

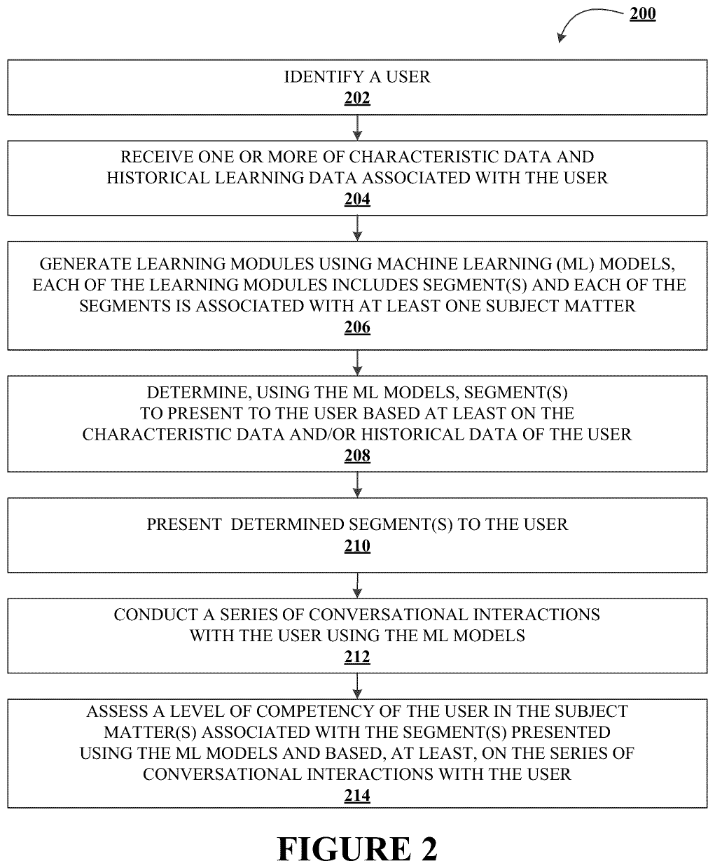

FIG. 2 illustrates a process flow 200 for implementing computer-based learning applications with conversational interactions using artificial intelligence, in accordance with an embodiment of the disclosure. In some embodiments, one or more systems for implementing learning applications with conversation interactions using artificial intelligence (e.g., similar to the system 130 described herein with respect to FIGS. 1A-1C, similar to the end-point device(s) described herein with respect to FIGS. 1A-1C, or the like.), perform the process flow 200.

As shown in block 202, the process flow 200 may include identifying a user. For example, a system (e.g., similar to the system 130 described herein with respect to FIGS. 1A-1C, similar to the end-point device(s) 140 described herein with respect to FIGS. 1A-1C, and/or the like) associated with an entity (e.g., a financial institution, a service provider, a business, or the like) may use the user's authentication credentials with the entity to identify the user. In some embodiments, a system may require a user to input authentication credentials for use of the learning application specifically. In other embodiments, a system may identify the user based on the user's online identifiers such as the user's username or IP address, GPS location, or any other identifying feature, or any combination of such factors.

As shown in block 204, the process flow 200 may include receiving one or more characteristic data or historical learning data associated with the user. Characteristic data may include a user's position in the organization or entity of which the user is a member, details of the user's work or role within the organization or entity, the user's educational background, or the like. Historical learning data may include prior trainings completed by the user, results of earlier training or educational modules that the user has passed, historical communications of the user with the learning application of the present invention, including communications in past sessions or earlier in a current session, or the like. In some embodiments, the characteristic data and the historical learning data may be pulled from the user's records within an organization or entity of which the user is a member.

In some embodiments of the invention, artificial intelligence and the machine learning models are used to concurrently update the historical learning data of the user as the user interacts with the learning application during and after any given session. Such updates allow the learning application to take into account all possible and most recent data about the user's learning to further interact with the user.

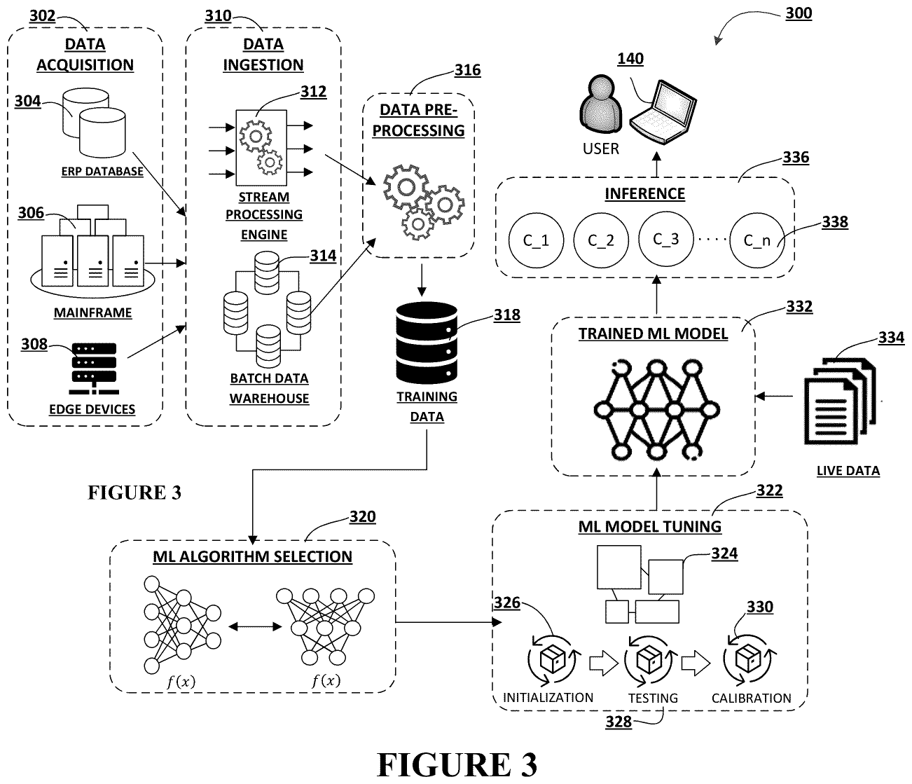

As shown in block 206, the process flow 200 may include generating segments using machine learning models, wherein each of the segments is associated with at least one subject matter. For example, a machine learning model (e.g., similar to the ML model 332 described herein with respect to FIG. 3) may first determine which subject matter(s) the user needs to be trained in. Such a determination may be based on the subject matter(s) associated with past segments presented to the user, the user's competency in the subject matter(s), or the like. The machine learning model may then generate a segment including learning material based on the determined subject matter, combination of subject matters, or combination of parts of different subject matters.

In some embodiments, the machine learning models may be trained by a body of knowledge that may include documents from lawmakers and regulators, policies and procedures of an organization or entity, or the like.

In some embodiments, the user may request or select subject matter(s) to be trained in through the learning application. In other embodiments, the user may also choose to revisit or relaunch previously generated segments from the user's history on the learning application. In one such embodiment, the previously generated segments may be ones that the user has already been presented. In such an embodiment, the machine learning model may take into account the user's performance in the selected segments in previous sessions to assess the user's competency in the material of those segments.

As shown in block 208, the process flow 200 may include determining, using the machine learning models, at least one segment to present to the user based at least on the one or more characteristic data or historical data of the user. For example, a machine learning model may determine which segment(s) to present to the user, and in which order, based on what the user is currently working on in the capacity of the user's position within an organization or entity, what segments were presented to the user in previous sessions, the user's competency in the subject matter(s) associated with the segment as assessed in prior sessions, the user's competency as assessed in each segment related to the current segment, or the like.

As shown in block 210, the process flow 200 may also include presenting to the user the determined segment(s). For example, a system may present the determined segment(s) to the user via display on end-point device(s) 140. In such embodiments, the segments may be presented and displayed in the form of text, audio, video, images, or any combination of these or other formats. Audio or video may be presented through a video platform, a livestreaming platform, a network, or the like, and may be human-, computer-, or AI-generated Images may be any visual representations of something, including photographs, drawings, diagrams, or the like, whether human-, computer- or AI-generated.

In one embodiment of the invention, the determined segments may be presented to the user in a pop-up window. Such a window would “pop-up” when the user is not actively engaged with the learning application and is engaged with a secondary application. In a further embodiment, a machine learning model may be employed to conduct conversational interactions with the user and assess the user's level of competency in the material (as described herein with respect to blocks 212 and 214 respectively) via the pop-up window. In another similar embodiment, the pop-window may launch the first time during a day that the user accesses the system (e.g., a 5-minute refresher via the pop-up window on the material presented to the user a previous day as soon as a user logs into the user's computer). In a still further embodiment, a machine learning model may be trained to trigger the launch of the pop-up window in certain circumstances, such as when the content of the user's interactions with a secondary application or the information being presented in a secondary application overlap with the learning application's own corpus of content and information. For example, if the user is reading about a specific topic on the internet and that topic is one that the user could be trained on through the learning application, the pop-up window would be launched while the user is on that webpage to train the user on that topic or a related topic.

As shown in block 212, the process flow 200 may also include conducting a series of conversational interactions with the user using artificial intelligence and the machine learning models. For example, a machine learning model (e.g., similar to the ML model 332 described herein with respect to FIG. 3), along with natural language processing technology, may be employed by the learning application to interact conversationally with the user. Such conversations may occur via text, with the machine learning model presenting information to the user, asking the user questions, responding to the user's questions, or the like and the user responding to the machine learning model's questions, asking questions about the information presented, or the like.

In some embodiments, such conversations may also occur via audio or video. In such embodiments, the system may be configured to receive the audio or video from the user. The user may use external devices, such as microphones or cameras for the user's audio or video input. The machine learning model may also present information in any combination of text, audio, video, images, or other formats. The system's output to the user, with the help of the machine learning models, and the user's input do not need to be in the same format (text, audio, video, images, or the like). The system's output and the user's input may use multiple formats in any given session of the learning application and may switch between formats as required. All such conversations, regardless of form or mode, may be conducted through the learning application as a platform for user interface.

As shown in block 214, the process flow 200 may also include assessing a level of competency of the user in the at least one subject matter associated with the at least one segment presented using the machine learning models and based, at least, on the series of conversational interactions with the user. For example, a machine learning model (e.g., similar to the ML model 332 described herein with respect to FIG. 3) may determine the user's competency in the subject matter presented to the user by analyzing the user interactions with the learning application. The machine learning model may take into account the content of the user's input during the interactions. In some embodiments, the machine learning model may also be trained to pick up hesitations (time taken to respond, typing speed, linguistic differences, use of filler words, or the like) that are not normally in the user's communications, based on historical interactions with the user, and may make a determination based on such hesitations as to the user's confidence in answers, confusion about the subject matter, or the like and may factor that into the assessment regarding the user's competency. In other embodiments, the machine learning models may be trained to pick up similar hesitations in other forms of communication (e.g., terms spoken, pauses taken, facial expressions, or the like).

In some embodiments, the machine learning models may be trained by experts who interact with the learning application and essentially ‘tell’ the machine learning models which user responses are good and which are not. Such training may enable the machine learning models to analyze the user's responses accordingly and assess the user's level of competency in the material.

In some embodiments, the learning application, using the machine learning models, may continue to interact with the user until the user achieves a threshold level of competency in the subject matter presented. The threshold level of competency may be based on the content of the subject matter material presented, the historical learning data of the user, and/or a combination of both. For example, the learning application may present the user with information on a specific topic. If the user does not seem to understand, the application may present the information in a different way or through a different mode (e.g., present a diagram if a paragraph of text does not seem to help.). The learning application may be configured to continue to present information until the user demonstrates an understanding of the material, or at least, a better understanding of the material than before. Such an iterative process could help the user retain information better as well. In such a case, the interactions of the current session would become part of the user's historical learning data and the learning application may present the subject matter(s) to the user again in future sessions to further improve the user's understanding of the material. In further embodiments, the threshold level of competency may be determined by the entity or organization of which the user is a member or through which the user is using the learning application.

In some embodiments, the machine learning models may assign micro-credentials to users in assessing a user's competency as indicators as to how any given user fares with respect to any given subject matter. Such micro-credentials may be presented to the user, or they may be stored internally as part of the user's historical learning data.

In some embodiments, subject matter(s) may be subject to change over time and the machine learning models would be trained to incorporate those changes into the segments they generate. The machine learning model would essentially be trained to keep the learning application's corpus of information up to date. For example, if one of the subject matters was about how to comply with a law or regulation and an amendment to the law or regulation was passed, the learning application would train the user on updated information including the amendment.

In some other embodiments, machine learning models are trained to use the characteristic data and historical learning data of a plurality of users of the learning application to determine which segment(s) to present to any one user and to assess the level of competency of the user. The machine learning models may also use the data of a plurality of users to establish a threshold level of competency for material to assess individual users. For example, if the learning application were to be used by an organization or an entity to train all of its employees, the learning application may use the historical learning data of all past and current employees to establish a threshold for new employees to meet. Another example is if there is particular material or subject matter that all employees tend to struggle with, the learning application may present may that into its determination of which segments to present to an individual user. In some embodiments, such data may also be compiled into statistical data or reports for the aid of the organization or entity through which the training is done.

In some embodiments of the invention, the invention may be used to incorporate the conversational interactions into existing learning tools. For example, the present invention may be a portion of a larger learning tool that is specifically intended to be the interactive and/or self-directed portion of the learning tool. In other embodiments, the present invention may supplement other types of training methods, such as instructor-led training.

FIG. 3 illustrates an exemplary machine learning (ML) subsystem architecture 300, in accordance with an embodiment of the invention. The machine learning subsystem 300 may include a data acquisition engine 302, data ingestion engine 310, data pre-processing engine 316, ML model tuning engine 322, and inference engine 336. In some embodiments, one or more systems for hosting a distributed network for providing entity services may include and/or use the machine learning subsystem 300 to perform one or more of the steps of one or more of the process flows described herein. For example, the artificial intelligence engine and/or the large language model described herein with respect to FIG. 2 may include and/or use the machine learning subsystem 300 to perform one or more of the steps of process flow 200.

The data acquisition engine 302 may identify various internal and/or external data sources to generate, test, and/or integrate new features for training the machine learning model 324. These internal and/or external data sources 304, 306, and 308 may be initial locations where the data originates or where physical information is first digitized. The data acquisition engine 302 may identify the location of the data and describe connection characteristics for access and retrieval of data. In some embodiments, data is transported from each data source 304, 306, or 308 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 304, 306, and 308 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 302 from these data sources 304, 306, and 308 may then be transported to the data ingestion engine 310 for further processing. In some embodiments, the data sources 304, 306, and 308 may include historical data associated with historical interactions between users and an entity (e.g., communications, transaction data, information entered in one or more data fields, terms spoken, pauses taken, typing speeds, facial expressions, and/or the like), data regarding the users, data regarding entities associated with the users, data regarding the entity, and/or Enterprise Resource Planning (ERP) databases that host data related to day-to-day business activities such as accounting, procurement, project management, exposure management, supply chain operations, and/or the like.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 302, the data may be ingested in real-time, using the stream processing engine 312, in batches using the batch data warehouse 314, or a combination of both. The stream processing engine 312 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 314 collects and transfers data in batches according to scheduled intervals, trigger events, or any other logical ordering.

In machine learning, the quality of data and the useful information that can be derived therefrom directly affects the ability of the machine learning model 324 to learn. The data pre-processing engine 316 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 316 may implement feature extraction and/or selection techniques to generate training data 318. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 318 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 322 may be used to train a machine learning model 324 using the training data 318 to make predictions or decisions without explicitly being programmed to do so. The machine learning model 324 represents what was learned by the selected machine learning algorithm 320 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 322 may repeatedly execute cycles of experimentation 326, testing 328, and tuning 330 to optimize the performance of the machine learning algorithm 320 and refine the results in preparation for deployment of those results for consumption or decision making. To this end, the ML model tuning engine 322 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 318. A fully trained machine learning model 332 is one whose hyperparameters are tuned and model accuracy maximized.

The trained machine learning model 332, similar to any other software application output, can be persisted to storage, file, memory, or application, or looped back into the processing component to be reprocessed. More often, the trained machine learning model 332 is deployed into an existing production environment to make practical business decisions based on live data 334. To this end, the machine learning subsystem 300 uses the inference engine 336 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 338) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 338) live data 334 based on how similar they are to one another to solve exploratory challenges where little is known about the data, provide a description or label (e.g., C_1, C_2 . . . . C_n 338) to live data 334, such as in classification, and/or the like. These categorized outputs, groups (clusters), or labels are then presented to the user input system 130. In still other cases, machine learning models that perform regression techniques may use live data 334 to predict or forecast continuous outcomes.

As noted, in some embodiments, one or more systems for dynamically generating output data in response to input communications using artificial intelligence described herein with respect to FIGS. 1A-1C and 2 may include and/or use the machine learning subsystem 300 to perform one or more of the steps of the process flows described herein. For example, the artificial intelligence engine and/or the large language model described herein with respect to FIG. 2 may include and/or use one or machine learning models similar to trained machine learning model 332 and/or one or more inference engines similar to the inference engine 336.

It will be understood that the embodiment of the machine learning subsystem 300 illustrated in FIG. 3 is exemplary and that other embodiments may vary. As another example, in some embodiments, the machine learning subsystem 300 may include more, fewer, or different components.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for implementing a learning application with conversational interactions, the system comprising:
an artificial intelligence system comprising:
one or more machine learning models, wherein the one or more machine learning models are trained to, at least:
generate one or more segments, wherein each of the one or more segments is associated with at least one subject matter;
determine at least one of the one or more segments to present to a user; and
assess a level of competency of the user in the at least one subject matter associated with the at least one segment presented; and
a learning application configured to:
identify the user;
receive one or more of characteristic data and historical learning data associated with the user;
determine, using the one or more machine learning models, the at least one segment to present to the user based, at least, on the one or more of characteristic data and historical learning data of the user;
present to the user the at least one determined segment;
conduct a series of conversational interactions with the user using the artificial intelligence system;
assess the level of competency of the user in the at least one subject matter associated with the at least one presented segment, using the artificial intelligence system and based, at least, on the series of conversational interactions with the user.

2. The system of claim 1, wherein the learning application is an interactive user application and wherein assessing the level of competency of the user comprises analyzing the conversational interactions with the user conducted through the learning application.

3. The system of claim 2, wherein analyzing user interactions comprises determining the time taken by the user to respond in the conversational interactions with the artificial intelligence system.

4. The system of claim 1, wherein assessing the level of competency of the user further comprises conducting the series of conversational interactions with the user until a threshold level of competency is determined to have been achieved by the user based at least on one of the at least one subject matter associated with the one or more presented segments and the historical learning data associated with the user.

5. The system of claim 1, wherein the learning application is configured to present the at least one determined segment to the user in a pop-up window while the user is both actively engaged with a secondary application and not currently engaged with the learning application.

6. The system of claim 5, wherein the learning application is configured to assess the level of competency of the user in the at least one subject matter associated with the at least one presented segment via the pop-up window.

7. The system of claim 6, wherein the artificial intelligence system triggers the learning application to present at least one of the one or more segments when at least one subject matter that the at least one segment is associated with is related to content in interactions of the user with the secondary application or to information presented in the secondary application.

8. The system of claim 1, wherein the one or more subject matters associated with the one or more segment changes over time, and wherein the one or more machine learning models are further trained to incorporate the changes into the segment.

9. The system of claim 1, wherein the one or more machine learning models are further trained to use the characteristic data and historical learning data of a plurality of users of the learning application to determine which of the one or more segments to present to the user and to assess the level of competency of the user.

10. The system of claim 1, wherein historical learning data associated with the user comprises data gathered by the artificial intelligence system when conducting the series of conversational interactions with the user and wherein the artificial intelligence system is configured to update the historical learning data during and after the series of conversational interactions with the user.

11. A computer-implemented method for implementing learning applications with conversational interactions, the method comprising:
generating one or more segments using one or more machine learning models, wherein each of the one or more segments is associated with at least one subject matter;
identifying a user;
receiving one or more of characteristic data and historical learning data associated with the user;
determining, using the one or more machine learning models, at least one of the one or more segments to present to the user based at least on the one or more of characteristic data or historical data of the user;
presenting the at least one determined segment to the user;
conducting a series of conversational interactions with the user using the one or more machine learning models;
assessing a level of competency of the user in the at least one subject matter associated with the at least one segment presented using the one or more machine learning models and based, at least, on the series of conversation interactions with the user.

12. The method of claim 11, wherein assessing the level of competency of the user comprises analyzing the conversational interactions with the user conducted through the learning application.

13. The method of claim 12, wherein analyzing user interactions comprises determining the time taken by the user to respond in the conversational interactions.

14. The method of claim 11, wherein assessing the level of competency of the user further comprises conducting the series of conversational interactions with the user until a threshold level of competency is determined to have been achieved by the user based at least on one of the at least one subject matter associated with the one or more presented segments and the historical learning data associated with the user.

15. The method of claim 11, wherein the at least one determined segment is presented to the user in a pop-up window while the user is both actively engaged with a secondary application and not currently engaged with the learning application.

16. A computer program product for implementing learning applications with conversational interactions, the computer program product comprising at least one non-transitory computer-readable medium having computer-readable program code portions embodied therein, the computer readable code portions comprising:
an executable portion configured to generate one or more segments using one or more machine learning models, wherein each of the one or more segments is associated with at least one subject matter;
an executable portion configured to identify a user and receive one or more of characteristic data and historical learning data associated with the user;
an executable portion configured to determine, using the one or more machine learning models, at least one of the one or more segments to present to the user based at least on the one or more of characteristic data and historical data of the user;
an executable portion configured to present the at least one determined segment to the user;
an executable portion configured to conduct a series of conversational interactions with the user using the one or more machine learning models;
an executable portion configured to assess a level of competency of the user in the at least one subject matter associated with the at least one segment presented using the one or more machine learning models and based, at least, on the series of conversation interactions with the user.

17. The computer program product of claim 16, wherein assessing the level of competency of the user comprises analyzing the conversational interactions with the user conducted through the learning application.

18. The computer program product of claim 17, wherein analyzing user interactions comprises determining the time taken by the user to respond in the conversational interactions.

19. The computer program product of claim 16, wherein assessing the level of competency of the user further comprises conducting the series of conversational interactions with the user until a threshold level of competency is determined to have been achieved by the user based at least on one of the at least one subject matter associated with the one or more presented segments and the historical learning data associated with the user.

20. The computer program product of claim 16, wherein the at least one determined segment is presented to the user in a pop-up window while the user is both actively engaged with a secondary application and not currently engaged with the learning application.
